(19) United States
(12) Patent Application Publication
(10) Pub. No.: US 2008/0255017 A1
(43) Pub. Date: Oct. 16, 2008

(54) Adhesive Agent For Sanitary Cleaning And Deodorization

(76) Inventors: Johannes Dettinger, Horb (DE); Matthias Fritz, Gomaringen (DE); Edgar Jaeschke, Filderstadt (DE)

Correspondence Address: KRIEGSMAN & KRIEGSMAN, 30 TURNPIKE ROAD, SUITE 9, SOUTHBOROUGH, MA, 01772, US

(21) Appl. No.: 11/791,402

(22) PCT Filed: Nov. 3, 2005
(86) PCT No.: PCT/EP05/11770

§ 371 Date: Jan. 16, 2008

(30) Foreign Application Priority Data
Nov. 23, 2004 (DE) 10 2004 056 554.6

(51) Int. Cl. C11D 17/00

(52) U.S. Cl. 510/191

(57) ABSTRACT

The invention concerns a sanitary agent for cleaning and/or disinfecting and/or diffusing perfume, said agent being adapted to be applied directly on the sanitary ware to which it adheres, only to be evacuated by being rinsed off after many of rinsing operations, and said agent comprising solvents, in particular water, surfactants and an adhesive belonging in particular to the group of nonionic surfactants or nonionic emulsifiers, a bleaching agent belonging to the group of oxygen- or halogen-releasing agents, and optionally other standard constituents such as thickening agents, dyes, preservatives, odorant substances, bleaching agents, bleaching agent stabilizers and/or activators.

The invention relates to an adhesive sanitary agent for cleaning and/or disinfecting and/or for fragrance release for sanitary objects such as toilet bowls.

These sanitary agents are viscous, generally pasty, gels which are applied directly to the surface of the sanitary object from a suitable container, adhere there and can flushed away only after a relatively large number of flushing operations. In general, these agents are at least partially liquid-crystalline.

As a result of the direct adhesion of the agent to the surface of the sanitary object it is not necessary to additionally provide containers such as the so-called “WC cages”, the use of which is perceived by the consumer as being unhygienic, particularly when replacing the sanitary agent and when cleaning the toilet.

Such adhesive sanitary agents are known from WO 99/66017. Besides surfactants, water and fragrances, they also comprise adhesion promoters, for example from the class of nonionic surfactants such as the polyalkoxyalkanes, and are viscous, solid or pasty agents. Polarization-microscopic analysis of the cleaning agents known from this printed specification shows that the agents comprise liquid-crystalline phases, in particular of hexagonal structures.

In order to prevent the surface of these adhesive agents from drying out and to provide an attractive and smooth surface irrespective of the number of flushes, it is proposed in DE 100 48 887 A1 to additionally add to the agent an aliphatic di-, oligo- or polyhydroxy compound or ethers thereof.

EP 1 318 191 discloses a sanitary agent which comprises, as adhesion promoter, compounds from the group of oligo- or polyethylene oxide and/or block polymers comprising oligo- and/or polypropylene oxide and/or oligo- and/or polybutylene oxide, the aryl ethoxylates or the alkylaryl ethoxylates.

These known adhesive sanitary agents can be applied in a simple and hygienic manner using a suitable device, adhere to the surface of the sanitary object, retain their shape and are not flushed away in their entirety even under the effect of water, but only gradually dissolve completely after a large number of flushes.

Furthermore, DE 103 56 254 A1 disclosed long-adherent sanitary agents which comprise anionic surfactants and nonionic surfactants as adhesion promoters and silicates as thickeners.

These agents are characterized by good handleability and a good cleaning effect. As a result of the ability of the agent to be applied directly, it is no longer necessary for the consumer to have to touch a possibly contaminated toilet cage when refilling. The consumer can also apply the agent in the amount desired by him and is not restricted to the packet amount envisaged by the manufacturer.

A further advantage of the known gel-like agents is that these are characterized by significantly better fragrance release compared to the cleaning agent shaped bodies.

To improve the cleaning and disinfecting power, it is known in the case of extruded cleaning agent shaped bodies such as rim blocks and also in-tank blocks, to use halogen-releasing agents as bleaches. However, difficulties arise with regard to the stability in the case of these known agents comprising halogen-releasing substances, as described, for example, in EP 0 462 643 A1, WO 92/18605 and EP 0 672 103 B1. Even under damp conditions, decomposition of the halogen-releasing agents and an undesired reaction of the halogen-releasing agents with other reactive constituents have been observed in the known blocks comprising halogen-releasing agents, and the above printed specifications and a large number of other publications have made numerous proposals as to how the problem of decomposition of the bleaches and attack by the bleaches on other sensitive substances in the known cleaning agents can be solved. Last but not least, on account of these difficulties, it has even been proposed to provide the cleaning agents in multiphase form, namely with one phase comprising bleach and a bleach-free phase containing the sensitive substances.

The object of the present invention is to provide a toilet cleaning and/or deodorization agent which, as well as being easy and hygienic to handle, has a high cleaning and disinfecting power.

Surprisingly, it has been found that, despite the instability, known from the prior art, of bleaches especially in a damp environment, it is possible to provide an agent which is able to be applied directly to the sanitary object that comprises water, adhesion promoter and anionic surfactants and contains halogen- and/or oxygen-releasing bleaches. Surprisingly, the high instability, known from the prior art, of the halogen- and/or oxygen-releasing substances does not arise or arises at least only to a slight degree in the gel-like cleaning agents comprising the adhesion promoters.

In the view of the applicant, this could possibly be attributed to the fact that decomposition, catalyzed by rough surfaces, of the halogen- or oxygen-releasing substances does not take place in the agents precisely as a result of the gel structure.

For the purposes of the invention, halogen-releasing agents are understood as meaning agents which release the halogens chlorine, bromine or iodine or hypohalides thereof.

The halogen- and/or oxygen-releasing bleaches according to the invention are the compounds from the group of carbonate peroxyhydrates, perborates, persulfates, peroxodisulfates, peroxophosphates, peroxonitrates, caroates, nitrates, dithionites, hypochlorites, chlorates, permanganates, in each case in the form of their alkali metal, ammonium or alkaline earth metal salts.

They are also the dichloroisocyanurates, trichloroisocyanurates, dibromoisocyanurates, tribromoisocyanurates, chloro-, bromohydantoins, the chlorinated trialkali metal phosphates, in each case in the form of their alkali metal, ammonium, alkaline earth metal salts, or as free acid.

They are also the hydrogen peroxides, organic peroxides, iodines, iodine PVP, bromines and monochloroamines, and chlorinated trisodium phosphates, calcium hypochlorites, lithium hypochlorites, monochloroamines, dichloroamines, [(monotrichloro)tetra(monopotassium dichloride)] pentaisocyanurates, 1,3-dichloro-5,5-dimethylidantonones, p-toluenesulfodichloramides, trichloromelamines, N-chloroamines, N-chlorosuccinimides, N,N′-dichloroazodicarboxamides, N-chloroacetylureas, N,N-dichlorobiurils, chlorinated dicyanodiamides and dichloroglycolureas.

Among the alkali metal salts, the sodium and potassium salts are particularly preferred, and among the alkaline earth metal salts, calcium is particularly preferred.

Hydrogen peroxide is to be used particularly preferably as bleach.

The halogen- or oxygen-releasing agents according to the invention may be present in the gel in a fraction from 1 up to 20% by weight, their fraction preferably being between 2 and 15% by weight and particularly preferably between 5 and 10% by weight.

In general, these compounds are essentially stable in the gel. If desired, however, the bleach can be additionally stabilized by adding a stabilizing agent. Stabilizing agents which may be used are urea, barbituric acid, hydrophobic compounds, such as, for example, mineral oils or other unreactive hydrophobic compounds, such as tertiary alcohols, complex esters or ketones. In some instances, these hydrophobic stabilizing agents can also simultaneously be perfuming substances and/or solubility control agents. Stabilizing agents which can be chosen are also complexing agents, such as phosphoric acid, sodium diphosphates, stannates, silicates, such as alkaline earth metal silicates, EDTA, NTA and citrates, for example in the case of the preferably oxygen-releasing bleaches, hydrogen peroxides, which complex heavy metals catalyzing a decomposition.

It is particularly preferred to use hydrogen peroxide as bleach according to the invention. Hydrogen peroxide is preferably used in a concentration of 30% in water, optionally stabilized. Hydrogen peroxide can be used as liquid or aqueous solution directly for producing the agent without, for example, the dissolution of a salt or the like being required. Furthermore, hydrogen peroxide is amazingly stable in the gel. The oxidizing effect of the hydrogen peroxide is also more selective than in the case of the corresponding chlorine-cleaving substances.

A further advantage of hydrogen peroxide is that neither the hydrogen peroxide, nor its oxidation products, namely oxygen, are colored and can thus adversely affect the appearance of the agent, as would be the case when using bleaches based on bromine or iodine, which under certain circumstances can then lead to a brown coloration of the agent.

However, depending on the desired color and also the intrinsic color, it is also entirely possible to use agents releasing iodine or bromine, especially if the gel has more sensitive constituents since the oxidizing potential of the agents releasing bromine and iodine is lower than that of the agents releasing chlorine or oxygen.

In order to prevent catalytic decomposition of the hydrogen peroxide in the gel, the gel should be free from heavy metals such as, for example, brownstone, Fe³⁺, Ca²⁺, and free from I⁻, IO³⁻.

If the oxidizing power of the bleach in the gel is to be increased, for example new more unreactive bleaches such as perborates are used, bleach activators, especially those based on N— or O-acyl compounds, such as, for example, tetraacetylethylenediamine (TAED), tetraacetylglycouril (TAGU), pentapropionylglucose (PPG) or pentaactylglycose (PAG) can be added.

The adhesion promoter, in the presence of water, causes the agent to adhere to the surface. In general, it forms network-like structures which bestow the agent with the required dimensional stability even under the action of strong forces due to flush water.

The molecules of the adhesion promoter are longer-chain or long-chain, essentially stretched molecules which are at least partially hydrophilic and thus comprise at least one hydrophilic radical or one hydrophilic group which interacts with water.

Preferably, the adhesion promoter should be unbranched molecules in order to permit the desired network formation.

The adhesion promoter can either be totally hydrophilic or else partially hydrophilic, partially hydrophobic.

Adhesion promoters which can be used are organic molecules with one hydrophilic end and one hydrophobic end. Hydrophilic radicals which can be used are, for example, polyalkoxy groups, preferably polyethoxy, polypropoxy or polybutoxy groups, or else mixed polyalkoxy groups, such as, for example poly(ethoxypropoxy) groups. It is particularly preferred to use, as hydrophilic end, a polyethoxy radical comprising between 15 and 100 ethoxy groups, preferably between 25 and 55 ethoxy groups and particularly preferably 35±5 ethoxy groups.

As hydrophilic end it is also possible to use anionic groups, for example sulfonates, carbonates or sulfates.

Stearates, in particular sodium or potassium stearate, are also suitable as adhesion promoters.

If the adhesion promoter molecules also have a hydrophobic end, straight-chain alkyl radicals, in particular, are suitable for the hydrophobic radical, particular preference being given particularly to even-numbered alkyl radicals because of the better biodegradability. In order to achieve the desired network formation of the adhesion promoter molecules, the molecules should be unbranched.

If alkyl groups are selected as hydrophobic radicals, then alkyl radicals with at least twelve carbon atoms are preferred. Particularly good results have been achieved using an alkyl chain length between 16 and 30 carbon atoms, in particular 16, 18, 20 and 22 carbon atoms.

Hydrophobic radicals which the adhesion promoters may also comprise are alkylbenzene radicals, for example dodecylbenzene or similar radicals, as is the case with the adhesion promoter sodium dodecylbenzenesulfonate.

A large class of adhesion promoters is formed by the nonionic surfactants and the nonionic emulsifiers.

According to the invention, the nonionic surfactants used are preferably alkoxylated, advantageously ethoxylated and/or propoxylated, particularly preferably ethoxylated, primary linear alcohols, in particular fatty alcohols, and/or fatty acids having preferably 8 to 22, particularly preferably 12 to 22, carbon atoms and on average 5 to 120 mol of ethylene oxide (EO) and/or 1 to 5 mol of propylene oxide (PO) per mole of alcohol, in which the alcohol radical may be linear or preferably 2-methyl branched, or may contain linear and methyl-branched radicals in a mixture, as are usually present in oxo alcohol radicals. However, alcohol ethoxylates with linear radicals from alcohols of native origin having 12 to 22 carbon atoms, for example from coconut, palm, tallow fatty or oleyl alcohol, and on average 20 to 100, in particular 20 to 80, EO per mole of alcohol, in particular, are preferred. Preferred ethoxylated alcohols include, for example, C₁₂₋₁₄-alcohols and/or tallow fatty alcohols having 30, 40, 50 or 60 EQ units and mixtures of these. The stated degrees of ethoxylation are, if appropriate, statistical averages, which may be an integer or a fraction for a specific product. Preferred alcohol ethoxylates have a narrowed homologue distribution (narrow range ethoxylates, NRE).

Preferred adhesion promoters are polyalkoxyalkanes, preferably a mixture of alkyl(C20-C20) ethoxylate with 35 EO or alkyl(C22) ethoxylate with 35 EO and alkyl(C16-C18) ethoxylate with 30 EO, but also alkylsulfonates, such as sodium dodecylbenzenesulfonate or alkyl carbonates or alkyl sulfates.

The use of a mixture of the adhesion promoters alkyl(C22) ethoxylate (35 EO) and alkyl(C16-C18) ethoxylate (30 EO) has a positive effect on the desired flush number in the sense of a reduction and the durability of the agent. Moreover, the joint use of these adhesion promoters achieves simple processability of the agent.

As the number of alkoxy groups decreases, the adhesion promoter becomes more lipophilic, as a result of which, for example, the solubility of perfume and thus the intensity of the fragrance can be increased.

Also preferred according to invention are C₁₂-C₂₂ fatty acid mono- and diesters of addition products of from 10 to 150 mol of ethylene oxide onto polyols having 3 to 6 carbon atoms, in particular onto glycerol, C₈-C₂₂-alkyl mono- and oligoglycosides and ethoxylated analogs thereof, addition products of from 20 to 150, in particular 20 to 100, especially 20 to 80 mol, of ethylene oxide onto castor oil or hydrogenated castor oil, partial esters of polyols having 3-6 carbon atoms with saturated fatty acids having 8 to 22 carbon atoms, fatty acid esters of sugars and sugar alcohols, such as sorbitol, which may optionally be alkoxylated with 4 to 150 mol of ethylene oxide and/or 0 to 5 mol of propylene oxide. Hydrogenated castor oil which has been alkoxylated with 40 EO units is available, for example, under the trade name Eumulgin® HRE 40 (Cognis). Castor oil which has been alkoxylated with 60 EO units is available, for example, under the trade names Eumulgin® HRE 60 (Cognis) and Cremophor® CO60 (BASF).

A further class of nonionic surfactants which can be used according to the invention, which can be used either as the sole nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain, in particular fatty acid methyl esters.

A further class of nonionic surfactants which can be used according to the invention are the alkyl polyglycosides (APGs). Alkyl polyglycosides which can be used have the general formula R—O(-G)₂, in which R is a linear or branched, in particular 2-methyl branched, saturated or unsaturated, aliphatic radical having 8 to 22, preferably 8 to 18, carbon atoms, G is a glycosidically bonded radical of a monosaccharide and z is a value between 1 and 10.

A further class of nonionic surfactants which can preferably be used, which can be used either as the sole nonionic surfactant or in combination with other nonionic surfactants, are alkoxylated, preferably ethoxylated or ethoxylated and propoxylated fatty acid alkyl esters, preferably having 1 to 4 carbon atoms in the alkyl chain.

Nonionic surfactants of the amine oxide type, for example N-cocoalkyl-N,N-dimethylamine oxide and N-tallowalkyl-N,N-dihydroxyethylamine oxide, and of the fatty acid alkanolamide type may be suitable. The amount of these nonionic surfactants is preferably not more than that -of the ethoxylated fatty alcohols, in particular not more than half thereof.

Further suitable surfactants are polyhydroxy fatty acid amides of the formula (II),

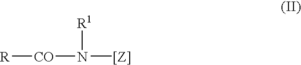

in which RCO is an aliphatic acyl radical having 6 to 22 carbon atoms, R¹ is hydrogen, an alkyl or hydroxyalkyl radical having 1 to 4 carbon atoms and [Z] is a linear or branched polyhydroxyalkyl radical having 3 to 10 carbon atoms and 3 to 10 hydroxyl groups. The polyhydroxy fatty acid amides are known substances which can usually be obtained by reductive amination of a reducing sugar with ammonia, an alkylamine or an alkanolamine and subsequent acylation with a fatty acid, a fatty acid alkyl ester or a fatty acid chloride.

The group of polyhydroxy fatty acid amides also includes compounds of the formula (III),

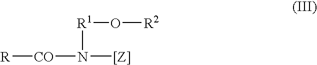

in which R is a linear or branched alkyl or alkenyl radical having 7 to 12 carbon atoms, R¹ is a linear, branched or cyclic alkyl radical or an aryl radical having 2 to 8 carbon atoms and R² is a linear, branched or cyclic alkyl radical or an oxyalkyl radical having 1 to 8 carbon atoms, where C₁₋₄-alkyl or phenyl radicals are preferred and [Z] is a linear polyhydroxyalkyl radical whose alkyl chain is substituted by at least two hydroxyl groups, or alkoxylated, preferably ethoxylated or propoxylated, derivatives of this radical.

The nonionic surfactants are preferably present in the gel in a concentration of 10-60% by weight, particularly preferably 10-30% by weight, especially 15-25% by weight.

As adhesion promoters, it is also possible to use molecules which generally act as thickeners in aqueous systems, for example hydrophilic substances, such as celluloses, polysaccharides, starch, xanthan gum, agar agar, gellan gum, gum arabic, carob seed flour or guar gum.

The concentration of the adhesion promoter to be used is dependent on its hydrophilicity and its ability to form networks. They may, for example, be 10 to 40% by weight, preferably between 15 and 35% by weight and particularly preferably between 20 and 30% by weight, which is preferred particularly when using polyalkoxyalkanes.

In order to provide the desired number of adhesive points with the adhesion promoter molecules by adding water, water should be present in the formulation at least to 20% by weight, preferably between 35 and 65% by weight, in particular between 40 and 60% by weight. The water fraction is dependent, inter alia, on the hydrophilicity of the adhesion promoter used.

Additionally, as solvents, in particular for dyes and perfume oils, for example alkanolamines, polyols, such as ethylene glycol, propylene glycol, 1,2-glycerol and other mono- and polyhydric alcohols may be present. The content of solvents is dependent on the type and amount of the constituents to be dissolved and is generally in the range from 0.5 to 5% by weight.

Surfactants which may be used are, in principle, all known anionic and cationic or amphoteric surfactants.

The anionic surfactants used are, for example, those of the sulfonate and sulfate type. Suitable surfactants of the sulfonate type here are preferably C₉₋₁₃-alkylbenzenesulfonates, olefinsulfonates, i.e. mixtures of alkane- and hydroxyalkanesulfonates, and disulfonates, as are obtained, for example, from C₁₂₋₁₈-monoolefins with terminal or internal double bond by sulfonation with gaseous sulfur trioxide and subsequent alkaline or acidic hydrolysis of the sulfonation products.

Also suitable are alkanesulfonates which are obtained from C₁₂-₁₈-alkanes, for example by sulfochlorination or sulfoxidation with subsequent hydrolysis or neutralization. Likewise suitable are also the esters of α-sulfo fatty acids (ester sulfonates), for example the α-sulfonated methyl esters of hydrogenated coconut, palm kernel or tallow fatty acids.

Further suitable anionic surfactants are sulfated fatty acid glycerol esters. Fatty acid glycerol esters are to be understood as meaning the mono-, di- and triesters, and mixtures thereof, as are obtained during production by esterification of a monoglycerol with 1 to 3 mol of fatty acid or during transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

As alk(en)yl sulfates, the alkali metal and in particular the sodium salts of the sulfuric acid half-esters of C₁₂-C₁₈-fatty alcohols, for example of coconut fatty alcohol, tallow fatty alcohol, lauryl, myristyl, cetyl or stearyl alcohol or of C₁₀-C₂₀-oxo alcohols and those half-esters of secondary alcohols of these chain lengths are preferred. Preference is also given to alk(en)yl sulfates of said chain length which contain a synthetic straight-chain alkyl radical produced on a petrochemical basis and which have an analogous degradation behavior to the equivalent compounds based on fat-chemical raw materials. From a washing aspect, the C₁₂-C₁₈-alkyl sulfates and C₁₂-C₁₅-alkyl sulfates, and C₁₄-C₁₅-alkyl sulfates are preferred. 2,3-Alkyl sulfates, which can be obtained as commercial products of the Shell Oil Company under the name DAN®, are also suitable anionic surfactants.

The sulfuric acid monoesters of the straight-chain or branched C₇₋₂₁-alcohols, ethoxylated with 1 to 6 mol of ethylene oxide, such as 2-methyl-branched C₉₋₁₁-alcohols having on average 3.5 mol of ethylene oxide (EO) or C₁₂₋₁₈-fatty alcohols having 1 to 4 EO are also suitable. On account of their high foaming behavior, they are used here only in relatively small amounts.

Further suitable anionic surfactants are also the salts of alkylsulfosuccinic acid, which are also referred to as sulfosuccinates or as sulfosuccinic acid esters and represent the monoesters and/or diesters of sulfo-succinic acid with alcohols, preferably fatty alcohols and in particular ethoxylated fatty alcohols. Preferred sulfosuccinates contain C₈₋₁₈-fatty alcohol radicals or mixtures of these. Particularly preferred sulfo-succinates contain a fatty alcohol radical derived from ethoxylated fatty alcohols which, when viewed per se, represent nonionic surfactants (for description see below). In this connection, particular preference is in turn given to sulfosuccinates whose fatty alcohol radicals are derived from ethoxylated fatty alcohols with a narrowed homologue distribution. It is also likewise possible to use alk(en)ylsuccinic acid having preferably 8 to 18 carbon atoms in the alk(en)yl chain or salts thereof. The anionic surfactants can be present in the form of their sodium, potassium or ammonium salts, and as soluble salts of organic bases, such as mono-, di- or triethanolamine. The anionic surfactants are preferably present in the form of their sodium or potassium salts, in particular in the form of the sodium salts.

According to the invention, the anionic surfactants used are particularly preferably fatty alcohol ether sulfates, alkyl sulfates, alkylbenzenesulfonates and/or alkanesulfonates. The anionic surfactants are preferably present in the composition in an amount of 10-75% by weight, particularly preferably 20-70% by weight, especially 30-70% by weight, in particular 40-65% by weight.

Besides the constituents according to the invention, the sanitary agent can comprise further customary constituents, for example perfume substances, disinfectants, preservatives, such as, for example, isothiazolone derivative, or foam stabilizers, such as coconut fatty acid amidopropylbetaine or coconut fatty acid amidopropyldimethylamine oxide, coconut fatty acid mono/diethanolamide or alkyl polyether glycerol ether sulfates, but also dyes and/or substances which dissolve limescale or urine scale in particular acids.

The additional perfume substances optionally present are those customary from the prior art. Examples which may be mentioned are mixtures of natural and synthetic fragrances. Natural fragrances are extracts from flowers (lily, lavender, rose, jasmine, neroli, ylang-ylang), stems and leaves (geranium, patchouli, petitgrain), fruits (anise, coriander, caraway, juniper), fruit peels (bergamot, lemon, oranges), roots (maize, angelica, celery, cardamom, costus, iris, calmus), woods (pinewood, sandalwood, guaiac wood, cedar wood, rosewood), herbs and grasses (tarragon, lemon grass, sage, thyme), needles and branches (spruce, fir, pine, dwarf-pine), resins and balsams (galbanum, elemi, benzoin, myrrh, olibanum, opoponax). Also suitable are animal raw materials, such as, for example, civet and castoreum. Typical synthetic fragrance compounds are products of the ester, ether, aldehyde, ketone, alcohol and hydrocarbon type. Fragrance compounds of the ester type are, for example, benzyl acetate, phenoxyethyl isobutyrate, p-tert-butyl cyclohexylacetate, linalyl acetate, dimethyl benzyl carbinyl acetate, phenylethyl acetate, linalyl benzoate, benzyl formate, ethylmethylphenyl glycinate, allyl cyclohexylpropionate, styrallyl propionate and benzyl salicylate. The ethers include, for example, benzyl ethyl ether, the aldehydes include, for example, the linear alkanals having 8 to 18 carbon atoms, citral, citronellal, citronellyloxyacetaldehyde, cylamenaldehyde, hydroxycitronellal, lilial and bourgeonal, the ketones include, for example, the ionones, α-isomethylionone and methyl cedryl ketone, the terpene alcohols include menthol, anethol, citronellol, eugenol, isoeugenol, geraniol, linalool, nerol, phenylethyl alcohol, tetrahydromyrcenol and terpineol, and the hydrocarbons include primarily the terpenes and balsams. However, preference is given to using mixtures of different fragrances which together produce a pleasing scent note.

Essential oils of lower volatility, which are mostly used as aroma components, are also suitable as perfume oils, for example sage oil, chamomile oil, oil of cloves, melissa oil, mint oil, cinnamon leaf oil, linden blossom oil, juniper berry oil, vetiver oil, oliban oil, galbanum oil, labolanum oil and lavandin oil. Preference is given to using bergamot oil, dihydromyrcenol, lilial, lyral, citronellol, phenylethyl alcohol, α-hexylcinnamaldehyde, geraniol, benzyl acetone, cyclamenaldehyde, linalool, boisambrene forte, ambroxan, indole, hedione, sandelice, lemon oil, mandarin oil, orange oil, allyl amyl glycolate, cyclovertal, lavandin oil, clary sage oil, β-damascone, geranium oil bourbon, cyclohexyl salicylate, vertofix coeur, iso-E-super, fixolide NP, evernyl, iraldein gamma, phenylacetic acid, geranyl acetate, benzyl acetate, rose oxide, romillat, irotyl and floramat, alone or in mixtures.

The amount metered in is dependent on the desired scent intensity and is preferably in the range from 5-15% by weight, particularly preferably from 8-12% by weight.

The perfume substances used should be essentially resistant to the bleaches in the gel.

It is also possible to add olefinsulfonates, ether sulfates and/or surfactants, in particular acid methyl taurides, as foamers with self-cleaning action to the agents according to the invention.

In order to prevent the agent from drying out, the agent can additionally also comprise preferably between 5 and 15% by weight of aliphatic di-, oligo- or polyhydroxy compounds or ethers thereof or of compound(s) from the group glycerol, 1,3-dihydroxypropane, 1,3- or 1,4-dihydroxybutane, 1,3-dihydroxyisobutane and/or pentaerythritol.

If desired, salts, such as, for example, sodium sulfate, can also be added to the formulation in order to increase the dissolution rate. The salt fraction can be up to 10% by weight, preferably up to 5% by weight.

The agent according to the invention can be applied and replaced in a hygienic manner without touching possibly contaminated devices attached to the toilet bowl.

An essential advantage of the agent according to the invention is that it can be portioned as the consumer desires. If the consumer desires more intense cleaning or if the toilet is used more often, then correspondingly higher doses can be used.

The agent according to the invention can also be applied in a simple manner simultaneously to different areas of the sanitary object, for example in order to achieve a uniform cleaning effect both on the right-hand side and also the left-hand side of a toilet bowl.

The adhesion achieved on the sanitary object, even in the case of application to a perpendicular surface, is so good that the agent does not come off even under the additional action of force of streams of flush water.

The sanitary agents according to the invention can only be flushed away after a relatively large number of flushing operations. The number of flushing operations is naturally governed by the composition of the particular sanitary agent, the amount applied and the geometry of the applied sanitary agent.

Preferably, the agent according to the invention is an ointment-like pasty and/or cream-like and/or liquid-crystalline gel which preferably has a hexagonal structure. The gels are essentially dimensionally stable so that they do not “run off” or “drip”.

The adhesion and also the form of the gels is retained despite the considerable forces (friction, deformation . . . ) which act as a result of the water flushing. Preferably, these pasty gels comprise 1 to 20% by weight of bleaches, about 1% by weight to 25% by weight, in particular 5 to 15% by weight, of fragrances, 1% by weight to 20% by weight, in particular 5 to 10% by weight, of anionic surfactants, 20% by weight to 40% by weight of adhesion promoters, between 1 and 20% by weight of humectants, 0 to 1% by weight of thickeners and 0% by weight to 5% by weight, preferably between 0 and 1% by weight, of preservatives, and about 35 to 65% by weight of water.

In this preferred embodiment, a-olefinsulfonates, methyl taurides and ether sulfates in particular are used as anionic surfactants.

An anionic surfactant which simultaneously acts as foamer which has proven to be useful is, in particular, alkyl(C12-C14) polyethylene glycol-(2 EO) ether sulfate triisopropanolammonium salt. This anionic surfactant is preferred since, in contrast to olefinsulfonate or tauride, it does not run even in relatively high concentrations.

Alkyl(C16-C18) ethoxylate (30 EO) and alkyl(C22) ethoxylate (35 EO) are preferably used as adhesion promoters and nonionic surfactants. The agent further comprises preferably 0 to 3% by weight of amine oxides, such as, for example, coconut fatty acid amidopropyldimethylamine oxide (35% strength), which is available from Rewo/Goldschmidt as foam stabilizer under the name Rewominox B204, and 0 to 2% by weight of thickener, such as, for example, a polysaccharide, in particular a xanthan gum, which is available, for example, from Rhodia under the name Rhodopol T. Preservatives which may be used are, for example, isothiazolone derivatives.

The gels can preferably be introduced into the toilet bowl by means of tubes, comparable with toothpaste tubes, syringes or cartridges and stay adhered there for a large number of successive flushing operations. The viscosities of these pasty gels, to be determined using a Haake viscometer, plate-cone system, sensor PK 5 1°, shear gradient of 25 s⁻¹ and 20° C., should be at least 15 000 mPas, usually at least 50 000 mpas, preferably at least 90 000 mPas and particularly preferably at least 110 000 mPas.

The invention is described below by reference to a working example and a comparative experiment.

1. Formulation of the inventive adhesive sanitary agent
containing hydrogen peroxide bleach.

| | Content | |
|---|---|---|
| | (% by | |
| Constituent | wt.) | |
| Alkyl(C22) ethoxylate (35 EO) | 12.5 | Adhesion promoter |
| Alkyl (C16-C18) ethoxylate | 12.5 | Adhesion promoter |
| (30 EO) | | |
| Alkyl(C12-C14) polyethylene | 6 | Anionic surfactant |
| glycol (2 EO) ether sulfate | | |
| triisopropanolammonium salt | | |
| Glycerol (99%) | 10 | Humectant |
| Color | 0.02 | |
| Perfume | 10 | |
| Hydrogen peroxide (30% strength) | 2 | Bleach |
| Water | ad 100 | |

The viscosity at 20° C. is about 120 000 mPas (Haake viscometer, plate-cone system , sensor PK 5 1°, shear gradient 25 s⁻¹).

The alkyl(C22) ethoxylate (35 EO) used was Imbentin V001/99 from Dr. W. Kolb A G, the alkyl(C16-C18) ethoxylate (30 EO) used was Imbentin 168S/300 from Dr. W. Kolb GmbH A G, the alkyl(C12-C14) polyethylene glycol (2 EO) ether sulfate triisopropanolammonium salt used was Marlinat 242/90 T from CONDEA GmbH, and the perfume used was Citrix Extra F548373 from Quest International.

Up until complete dissolution, the agent according to the invention had a smooth and transparent surface of the gel, even in cases of a low flush frequency of four flushes per day. The dissolution process was largely independent of the flush frequency.

### 2. Investigation of the Storage Stabilization of the Hydrogen Peroxide Used

A gel according to formulation 1 was prepared and stored for eight weeks at indoor temperature and in daylight. Then, a 0.5% strength aqueous solution was prepared from this, and the H₂O₂ concentration was determined using test strips.

The detection method used was the “Merckoquant 1.10011” peroxide test.

This is an enzymatic test in which peroxidase (POD) transfers the peroxide oxygen to an organic redox indicator and in so doing converts to a blue oxidation product.

Here, no H₂O₂ reduction was found compared to a freshly prepared bleach gel.

The experiment demonstrates the storage stability of the bleach in the agent.

1. A sanitary agent for cleaning and/or disinfecting and/or for fragrance release, said agent being able to be applied directly to the sanitary object, adheres there and can be flushed away only after a relatively large number of flushing operations and which agent comprises solvents, in particular water, surfactants and an adhesion promoter, in particular from the group of nonionic surfactants or nonionic emulsifiers, a bleach from the group of oxygen- or halogen-releasing agents, and optionally further customary constituents such as thickeners, dyes, preservatives, fragrances, bleaches, stabilizers and/or bleach activators.

2. The sanitary agent as claimed in claim 1, characterized in that the viscosity of the agent is at least 15 000 mPas, measured using a Haake viscometer, plate-cone system, sensor PK 5 1°, measured at a shear gradient of 25 s⁻¹ and room temperature.

3. The sanitary agent as claimed in claim 1, characterized in that the bleach is selected from the group of carbonate peroxyhydrates, perborates, persulfates, peroxodisulfates, peroxophosphates, peroxonitrates, caroates, nitrates, dithionites, hypochlorites, chlorates, permanganates, in each case in the form of their alkali metal, ammonium or alkaline earth metal salts, the dichloroisocyanurates, trichloroisocyanurates, dibromoisocyanurates, tribromoisocyanurates, chloro-, bromohydantoins, the chlorinated trialkali metal phosphates, in each case in the form of their alkali metal, ammonium, alkaline earth metal salts, or as free acid, hydrogen peroxide, the organic peroxides, iodine, iodine PVP, bromine, monochloroamine, the chlorinated trisodium phosphates, monochloroamine, dichloroamine, [(monotrichloro)tetra(monopotassium dichloride)]pentaisocyanurates, 1,3-dichloro-5,5-dimethylidantonones, p-toluenesulfodichloramides, trichloromelamines, N-chloroamine, N-chlorosuccinimide, N,N′-dichloroazodicarboxamide, N-chloroacetylurea, N,N-dichlorobiuril, the chlorinated dicyanodiamides and dichloroglycolurea, where, among the alkali metal salts, the sodium and potassium salts are particularly preferred, and among the alkaline earth metal salts, the calcium salts are particularly preferred.

4. The sanitary agent as claimed in claim 1, characterized in that the agent comprises between 1 and 20% by weight, preferably between 2 and 15% by weight and particularly preferably between 5 and 10% by weight of bleaches.

5. The sanitary agent as claimed in claim 1, characterized in that the agent additionally comprises an agent for stabilizing the bleaches and the stabilizing agent is selected from the group of ureas, barbituric acid, hydrophobic compounds and complexing agents.

6. The sanitary agent as claimed in claim 2, characterized in that the bleach is selected from the group of carbonate peroxyhydrates, perborates, persulfates, peroxodisulfates, peroxophosphates, peroxonitrates, caroates, nitrates, dithionites, hypochlorites, chlorates, permanganates, in each case in the form of their alkali metal, ammonium or alkaline earth metal salts, the dichloroisocyanurates, trichloroisocyanurates, dibromoisocyanurates, tribromoisocyanurates, chloro-, bromohydantoins, the chlorinated trialkali metal phosphates, in each case in the form of their alkali metal, ammonium, alkaline earth metal salts, or as free acid, hydrogen peroxide, the organic peroxides, iodine, iodine PVP, bromine, monochloroamine, the chlorinated trisodium phosphates, monochloroamine, dichloroamine, [(monotrichloro)tetra(monopotassium dichloride)]pentaisocyanurates, 1,3-dichloro-5,5-dimethylidantonones, p-toluenesulfodichloramides, trichloromelamines, N-chloroamine, N-chlorosuccinimide, N,N′-dichloroazodicarboxamide, N-chloroacetylurea, N,N-dichlorobiuril, the chlorinated dicyanodiamides and dichloroglycolurea, where, among the alkali metal salts, the sodium and potassium salts are particularly preferred, and among the alkaline earth metal salts, the calcium salts are particularly preferred.

7. The sanitary agent as claimed in claim 2, characterized in that the agent comprises between 1 and 20% by weight, preferably between 2 and 15% by weight and particularly preferably between 5 and 10% by weight of bleaches.

8. The sanitary agent as claimed in claim 3, characterized in that the agent comprises between 1 and 20% by weight, preferably between 2 and 15% by weight and particularly preferably between 5 and 10% by weight of bleaches.

9. The sanitary agent as claimed in claim 6, characterized in that the agent comprises between 1 and 20% by weight, preferably between 2 and 15% by weight and particularly preferably between 5 and 10% by weight of bleaches.

10. The sanitary agent as claimed in claim 2, characterized in that the agent additionally comprises an agent for stabilizing the bleaches and the stabilizing agent is selected from the group of ureas, barbituric acid, hydrophobic compounds and complexing agents.

11. The sanitary agent as claimed in claim 3, characterized in that the agent additionally comprises an agent for stabilizing the bleaches and the stabilizing agent is selected from the group of ureas, barbituric acid, hydrophobic compounds and complexing agents.

12. The sanitary agent as claimed in claim 6, characterized in that the agent additionally comprises an agent for stabilizing the bleaches and the stabilizing agent is selected from the group of ureas, barbituric acid, hydrophobic compounds and complexing agents.

13. The sanitary agent as claimed in claim 4, characterized in that the agent additionally comprises an agent for stabilizing the bleaches and the stabilizing agent is selected from the group of ureas, barbituric acid, hydrophobic compounds and complexing agents.

14. The sanitary agent as claimed in claim 7, characterized in that the agent additionally comprises an agent for stabilizing the bleaches and the stabilizing agent is selected from the group of ureas, barbituric acid, hydrophobic compounds and complexing agents.

15. The sanitary agent as claimed in claim 8, characterized in that the agent additionally comprises an agent for stabilizing the bleaches and the stabilizing agent is selected from the group of ureas, barbituric acid, hydrophobic compounds and complexing agents.

16. The sanitary agent as claimed in claim 9, characterized in that the agent additionally comprises an agent for stabilizing the bleaches and the stabilizing agent is selected from the group of ureas, barbituric acid, hydrophobic compounds and complexing agents.
